(19) United States
(12) Patent Application Publication
(10) Pub. No.: US 2024/0163524 A1
(43) Pub. Date: May 16, 2024

(54) User Engagement

(71) Applicant: Angel Studios, Inc., Provo, UT (US)

(72) Inventors: Seth Taylor, Provo, UT (US); Ajay Madhok, Provo, UT (US)

(21) Appl. No.: 18/377,240

(22) Filed: Oct. 5, 2023

Related U.S. Application Data
(60) Provisional application No. 63/413,316, filed on Oct. 5, 2022.

(51) Int. Cl. H04N 21/488

(52) U.S. Cl. CPC H04N 21/4882; H04N 21/482

(57) ABSTRACT

An electronic media player comprises an interface for notifying a consumer/viewer of media content that another individual paid for the viewer's consumption of the media content.

### CROSS-REFERENCE TO RELATED APPLICATIONS

This application claims priority to U.S. Provisional Application No. 63/413,316 (“'316 Application”), which was filed on Oct. 5, 2022, the first inventor of which was Seth Taylor, and which was titled “Improvements in User Engagement.” The '316 Application is incorporated herein by reference in its entirety.

### BRIEF DESCRIPTION OF THE DRAWINGS

FIG. 1 shows an exemplary interface having an incrementing view counter and links for other features as described herein.

FIG. 2 shows an exemplary interface for viewing and/or buying scenes from media content.

FIG. 3 shows an exemplary interface for viewing and/or buying scenes from media content, as well as for viewing tags associated with content and/or a scene from the content.

### DETAILED DESCRIPTION OF THE INVENTION

### Background

In the disclosure herein, “consuming” content is used to generally describe ways that a person may consume audiovisual or other media content. Consumption often comprises watching and listening, but consumption could also comprise watching without sound, listening without visual, or any other mode of perceiving media content.

The disclosure herein below references “pay-it-forward” contributions/donations. In general, a pay-it-forward donation is a payment (in money or possibly other currency, e.g., cryptocurrency, etc.) made by a first person toward a second person's future (relative to the time of the payment) consumption of content. In some embodiments “pay-it-forward” may be broadly construed to include a first party's payment toward a second party's consumption of content regardless of the timing of the second party's consumption of content relative to the time at which the pay-it-forward payment was made. In general, the term “pay-it-forward” usually refers to a first party paying for something for a second party, often for something the second party will consume in the future.

Pay-it-Forward

The cost of creating and distributing content may be paid in whole or in part under a pay-it-forward paradigm. In a pay-it-forward paradigm the content may be provided to some or all users (“beneficiaries”) for no cost, and the actual cost of creating and distributing may be borne in whole or in part by a benefactor. For example, a benefactor may be another user who has consumed the content and has determined to pay it forward by making a donation/payment for others to consume the content.

In one embodiment, a content producer/distributor may determine that the cost of creating and distributing content is $1.00 per view. Any user or other benefactor who makes a pay-it-forward payment/donation may be understood to be financing consumption of the content for the number of beneficiary users that is the result of dividing the amount donated by $1.00. For example, donating $150 would fund 150 views (e.g., streaming) of the content. Many variants on this scheme could be implemented. For example, a user/benefactor could partially fund other views, e.g., at 50%, so that a donation of $150 would pay to subsidize 50% of 300 views.

Benefactor Notification

In one embodiment, when a beneficiary-user interacts with an interface element to begin or continue consuming content, the interface may indicate to the user that “This was made free for you by [“benefactor” or benefactor name or benefactor identifier].” The interface may present this message, or a similar message, to a beneficiary user at the beginning of, during, at the end of, or otherwise in association with presentation of content to the beneficiary user. In one embodiment, this benefactor notification may be presented to a beneficiary-user after the beneficiary-user has completed consuming the content, or after the beneficiary-user has ceased consuming the content, for example by text message, email, push notification, app, or messaging service/platform, or other means of communication.

Thank-You for Pay-it-Forward Benefactor

In one embodiment, while a user interface is presenting content to a user for consumption, or after or at or near the end of presentation of such content for consumption, the user interface may present one or more controls or interface elements to communicate/indicate to the user the identity of an individual or entity who paid for, financed, or subsidized the cost for the user to consume the content. For example, an interface element may communicate to the user, “This was made free for you [or “subsidized by,” or “financed by” ] by [“benefactor” or benefactor name or identifier].

The user interface may additionally present to the user an interface element that allows a beneficiary-user to thank, send a thank you to, or otherwise communicate with, a benefactor who paid for, financed, or subsidized the cost for the beneficiary-user to consume the content. For example, the user interface may present an interface element for thanking the benefactor, e.g., a button labeled “Thank [“benefactor” or benefactor name or identifier],” and when the beneficiary user selects or “presses” the button, a thank you message may be sent to the benefactor, or an interface may be presented to allow the user to type in, enter (e.g., video, audio, image, etc.) a message, or to otherwise create or select a message. The message/communication may be provided to the benefactor by text message, email, phone, messaging technology, app, or any other way known in the art for transmitting and/or presenting a message/communication.

Scope of Influence

In one embodiment, a user interface may present to a pay-if-forward benefactor a report about, summary of, or visualization of the scope of the benefactor's influence. In one example, a pay-it-forward server may store data reflecting benefactor-beneficiary associations. A benefactor-beneficiary association may comprise a benefactor identifier, a beneficiary identifier, a content identifier, a date (or time period), a benefit description, and a donation identifier. A content identifier may be identification of the content for which the benefactor provided a benefit to the beneficiary. The date (or time period) may be the date on which the beneficiary consumed, or began consuming, or finished consuming, the content identified by the content identifier. The benefit description may be “paid for,” or “partially subsidized,” or “partially subsidized in [amount],” or some other description of the manner in which the benefactor allowed, or helped to allow, the beneficiary to consume the content referenced by the content identifier. The donation identifier may identify a specific donation made by the benefactor, for example a donation of a specific amount made on an earlier date as distinguished from a donation made by the same benefactor on a later date.

The data stored in the pay-it-forward server may be presented in many different ways, for example: (1) the number of beneficiaries that were able to consume specific content thanks to a benefactor's specific donation; (2) the number of beneficiaries who were able to consume specific content over all (or more than one) of the benefactor's donations; (3) the number of beneficiaries who were able to consume any content thanks to a benefactor's specific donation; (4) the number of beneficiaries who were able to consume any content thanks to all (or more than one) of the benefactor's donations; (5) for any of the previous examples, or for any other examples, the identities of some or all of the beneficiaries who were able to consume content thanks to the benefactor; (6) summary characteristics of beneficiaries, e.g., age, geographic location, other demographic characteristics, donation-activity history (e.g., was the beneficiary previously a pay-it-forward benefactor? has the beneficiary since become a pay-it-forward benefactor? have the beneficiary's pay-it-forward donations increased?), content consumption history (e.g., first-time consumer of specific content or of a specific show/senes or of a specific type/genre of content?).

In one embodiment, graphical representations of data stored in the pay-it-forward server may comprise a geographic map showing one or more locations of a pay-it-forward benefactor's beneficiaries, e.g., a world map showing locations of beneficiaries. This may be referred to as an “impact world map” or a “world impact map.” In some embodiments the world impact map may be presented as a heat map. Geographies other than the entire world may also be used for a geographic impact map. Other graphical representations may be presented to a user to summarize or represent data stored in the pay-it-forward server.

In some embodiments the presentation of pay-it-forward data may be limited to direct impact, i.e., beneficiaries who consumed content paid for by the benefactor. In other embodiments, the presentation of pay-it-forward data may include and/or reflect some measure of indirect impact. For example, the user interface may report, or provide a graphical interface that reflects, individuals or users whose consumption of content has been financed, in whole or in part, by multi-level indirection beneficiaries. For example, a level-2-indirection beneficiary relationship may indicate that the beneficiary's benefactor was himself/herself a beneficiary of an original benefactor. Indirect beneficiary relationships may have any number of levels of indirection, or may be limited, e.g., one level of indirection (“level-2-indirection beneficiary”), or two levels of indirection (“level-3-indirection beneficiary”), or three levels of indirection (“level-4-indirection beneficiary”), etc. All of the representations described above can be modified, altered, or adapted to reflect and/or incorporate indirect beneficiary relationships. In one embodiment, the system may present to a user controls and/or other interface elements for the user to select the number of levels of indirection to be displayed or otherwise represented for pay-it-forward benefactor influence.

An indirect or multi-level impact interface may presented in a tree format, e.g., like a family tree, showing impact at branch and node levels, and may allow the user to expand nodes or to zoom/expand into different areas of the tree interface to review details of multi-level/indirect benefactor-beneficiary relationships.

In some embodiments, an entire “page” or “tab” or “window” may be devoted, or principally devoted, to apprising a pay-it-forward user of his/her impact and/or influence resulting from his/her one or more pay-it-forward donations.

In one embodiment, a pay-it-forward benefactor may receive one or more emails (or other types of communications) comprising aggregations or summaries of multiple thank you notes or other communications from pay-it-forward beneficiaries.

My Benefactors Interface

Some embodiments may include an interface for communicating or showing to a user the user's benefactor(s), i.e., the users/individuals who have directly or indirectly paid for, subsidized, or otherwise financed content that the user has consumed. For example, the interface may present to the user interface elements identifying or reflecting the user's pay-it-forward benefactors for specific content. For example, the interface may present to the user interface elements allowing the user to identify or review some or all content that the user has consumed. For example, the user may have consumed 10 episodes over two seasons from a show called “The Chosen.” The interface may present to the user, for each of the ten episodes, an indication of a benefactor who made a pay-it-forward donation to fund the user's consumption of the episode. For example, for season 1 episode 2, which the user may have completed watching, the interface may indicate that the user “biggest_chosen_fan_27” made a pat-it-forward donation on Jun. 27, 2022 and that this specific donation paid for the user to consume (watch) that episode of the chosen. This interface may show all content at once that the user has consumed, or may provide an interface for the user to navigate and select the content for which the user desires to review benefactor information.

Just as with impact/influence information as described herein above, the my-benefactor interface may present to the user information about indirect benefactor relationships. For example, the interface may present a tree interface with branches and nodes, allowing the user to traverse the tree structure to explore benefactor-beneficiary relationships. The tree structure may include summary and detailed information in graphical, textual, and/or hybrid formats, and may allow for expansion, collapse, and other summary information.

Possible information about a benefactor may include, but is not limited to, information about the benefactor's benefactor(s), information about the users/individuals that the benefactor has benefitted through pay-it-forward donations or otherwise, geographic information about the benefactor, and information about the benefactor's impact through pay-it-forward contributions.

The my-benefactor interface may additionally present, for one or more benefactors, an interface for messaging or otherwise communicating with the benefactor. For example, the interface may present a control that, when selected by the user, results in presentation of an interface for composing a message to the benefactor, selecting a message for the benefactor, recording a video/audio message for the benefactor, voice calling the benefactor, video calling the benefactor, reviewing messages from the benefactor, or communicating with the benefactor using any other communication means known in the art.

Benefactor Dedication/Introduction/Comment

In some embodiments the presentation of content to a beneficiary-user may incorporate or include a message or communication from the benefactor for that particular instance of content consumption. For example, before presenting the content to the beneficiary-user, a dedication from the benefactor may be presented to the beneficiary-user. The dedication may be a video message, or audio-only message, or text message, or any other type of media communication known in the art. The message may be pre-recorded or, in some embodiments, may be real-time, i.e., the benefactor may receive a notification that a beneficiary-user is about to consume content for which the benefactor's pay-it-forward contribution is being used, and may be presented with an opportunity to provide a real-time video, audio, text, or other message/communication in conjunction with the beneficiary-user beginning to consume the content. The dedication/message may be something like, “Hi! So glad you are watching [name of content]! This episode was especially meaningful to me because [reason]. Enjoy!” The dedication/message could be something other than a dedication-type message, e.g., a comment related to the content. For example, “keep an eye out for the singing mouse in the bottom-right corner when they are walking down the rainy forest path.” The dedication/message may be presented at the beginning, during, or at the end of the content, or otherwise in conjunction with the content, e.g., in an email sent to the user after the user begins or completes consuming the content. In some embodiments, an interface element may be presented to the beneficiary-user to allow the user to decide whether and/or when to consumer/view the benefactor dedication/message.

Benefactor-Beneficiary Relationships

In some embodiments, the interface may allow a benefactor and beneficiary to have a conversation-style interaction in which they continue to exchange messages/communications for a limited time into the future or for an unlimited time into the future.

View Counter

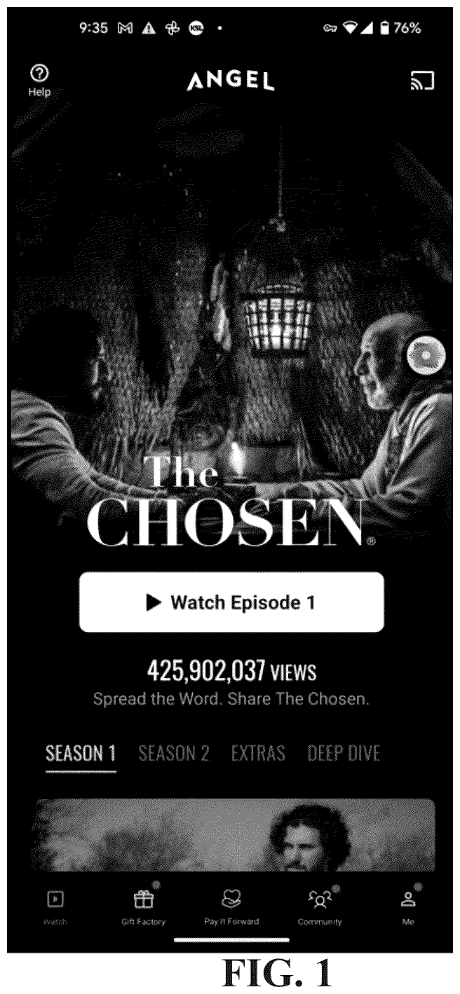

In some embodiments, the user interface may present an interface element reporting the number of times content has been consumed, e.g., a view counter as shown in FIG. 1. This counter may reflect the number of times any episode from a series has been viewed, or how many times a specific episode has been viewed, or any other type of view counter. The view counter may be real-time, showing increments as they happen.

In some embodiments, the user interface may present an interface element indicating the number of currently active views. For example, if a user has selected (or has been presented with an option to select) to consume episode 3 of season 2 of a show, then an interface element may be presented to indicate the number of currently active views of episode 3 of season 2, e.g., 1,317 views of episode 3 of season 2 are active at that time. Counting the number of active views/streams could comprise counting the number of views that have been begun but not completed (which would include pauses of any length), or counting only the number of active streams, e.g., actively streaming and is not currently paused for more than 15 minutes. Additionally, a count of active views could reflect all content for a series, or a specific episode of a series, or any other set or subset of content.

The live views counter may additionally present a geographic map, or geographic heat map, or another graphical, textual, or hybrid representation of the characteristics of the current viewers.

In one embodiment, the interface element that shows the counter may be configured to link to or present (upon selection or “pressing”) an impact/influence interface (as described herein above) to provide information about the impact of a user's pay-it-forward contributions. The interface element that shows the counter may also be configured to link to, or may show, a global thank-you note feed comprise some or all thank you notes and/or messages from beneficiaries to pay-it-forward benefactors.

In another embodiment the system may present a graphical, textual, or other representation of the impact/influence of all pay-it-forward benefactors (or a subset of pay-it-forward benefactors) for a set of content.

Collection-oriented Acquisition of Content NFTs

Content may be conceptually divided into segments, scenes, context, and/or frames. In general, a frame is the shortest unit of digital visual content. In one exemplary scheme, sub-parts of visual content may be referred to, going from shortest to longest, as frames, context(s), scenes, segments, and episodes or full versions.

Frames, context(s), scenes, segments, and/or full episodes/content may be minted as NFTs (non-fungible tokens).

A marketplace server may store information about ownership, sales, purchases, and/or other transactions of NFTs representing (and/or otherwise associated with) NFTs of frames, contexts, scenes, segments, and/or full episodes/content.

In one embodiment an interface may be presented to a user comprising interface elements for purchasing or otherwise acquiring a collection of NFTs representing a collection of frames (or contexts, scenes, segments, and/or full episodes/content). The following discussion will focus on frames, but the principles could be applied similarly to contexts, scenes, segments, full episodes/content, etc.

A collection of NFT-frames may comprise frames from the same episode or having some other association or commonality. In one embodiment, the frames may be specifically identified by a timestamp and/or SMPTE code, and this information may be presented to a user (who may be a potential purchaser). In another embodiment, the frame identification information may not be presented to the user (who may be a potential purchaser), and instead the only information provided to the user may be that all of the frames in the collection of frames are from the same context, scene, segment, and/or episode. This is somewhat analogous to a pack of baseball cards, in which it is known that all of the cards in the pack will be for players in the same league and during the same season, but from the perspective of the buyer the identities of the actual players are random and unknown.

For example, the interface may present to a user an opportunity to purchase (or otherwise acquire) ten frame-NFTs from season 2 episode 5 of a show. These ten frames may be randomly selected from season 2 episode 5. In one embodiment, some frames from season 2 episode 5 may have been already purchased/acquired and/or may be unavailable for other reasons. The interface may present an indication to the user of the probably of getting frames from a specific context, scene, or segment. For example, the most memorable scene in season 2 episode 5 of the show may be a scene in which Bob gasps as he discovers that, due to a genetic condition, his wife Molly's heart is in her left forearm instead of in her chest. This scene may be associated with a beginning and ending timestamp and a set of frames.

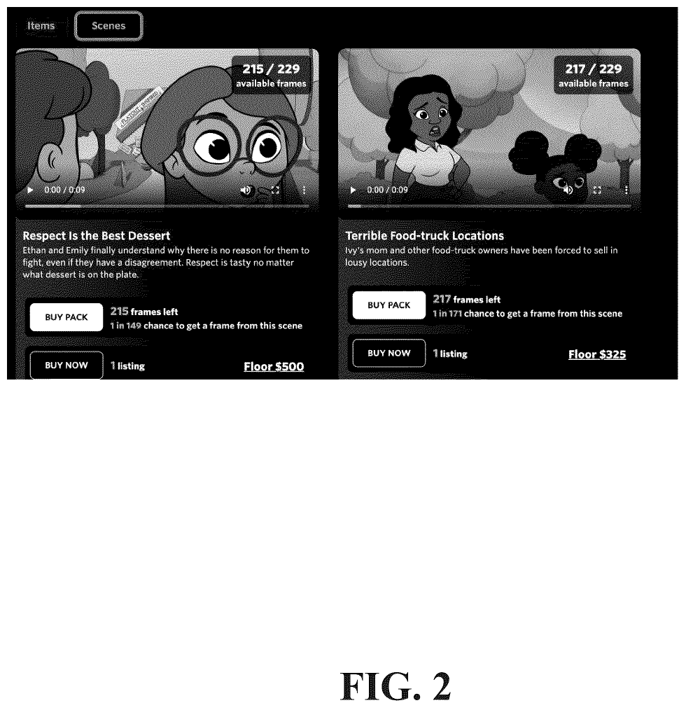

It may be desirable to own a frame-NFT from this scene. Depending on the number of frames still available from the episode, and the number of frames available from the episode that are from the desirable scene, the user interface may present to the user a probability that the user will get a frame from the desirable scene of the user purchases a ten-pack collection of frames randomly selected from frames still available from the episode. For example, the user interface may provide a fraction estimate of the likelihood that ten-pack of frames will include a frame from the desirable scene, or otherwise of the probability that each frame in the ten-pack may include a frame from the desirable scene, as shown in FIG. 2:

Metatags

Content and/or segments of content may be associated with metatags. A metatag may be any concept, sentiment, or emotion associated with the segment. Metatags may include, e.g., prayer, faith, hope, family, funny, drama, tension, love, peace, etc. Many more metatags may be used, and the universe of available metatags may depend on the genre/characteristics of specific content. In some embodiments, e.g., in which the content comprises religious materials, metatags could include references to Bible passages or to other scripture passages.

In one embodiment, a user interface for playing content or for showing summaries of or references/links to content may additionally indicate the metatags associated with such content.

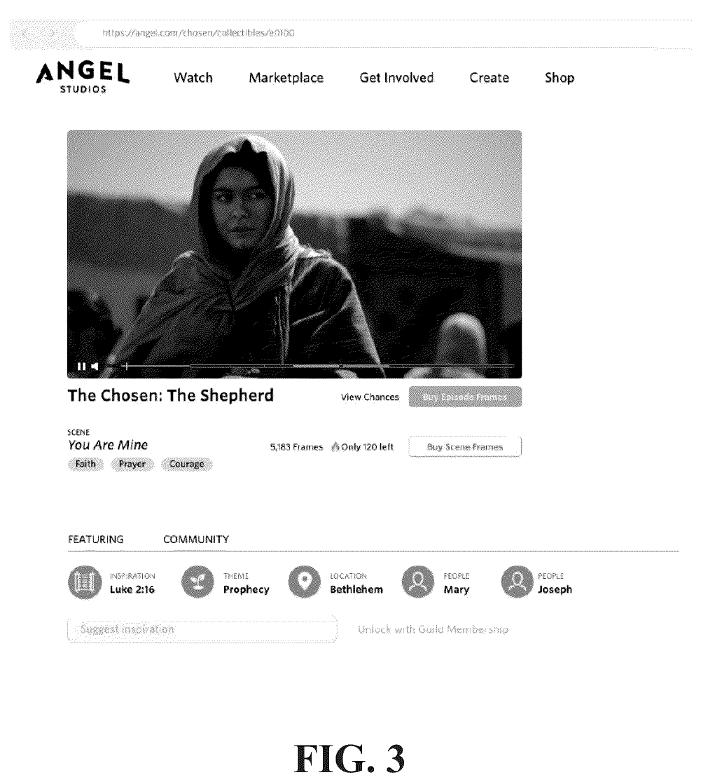

The image in FIG. 3 shows an interface for playing content that identifies three metatags, “Faith,” “Prayer,” and “Courage,” associated with the scene “You Are Mine.” Metatags could be presented to a user/consumer in many ways or through many interfaces or variations of interfaces.

Metatags may be assigned to content segments by users, curators, user voting (i.e., using voting algorithms over multiple users to determine the most appropriate metatags), or by using automated approaches such as artificial intelligence.

A content database or content store or metatag database may store metatag information, e.g., metatags and associations between metatags and content segments.

The system may present to a user an interface for adding and/or suggesting metatags. Such interface may comprise an interface element for selecting one or more metatags and/or for indicating a start time and/or stop time for the metatag(s).

The system may provide an interface for searching content by metatags. For example, an interface element may allow a user to search for content associated with the metatag “Prayer,” and in response to such a search may present a results interface showing episodes, segments, scenes, contexts, or frames associated with the “Prayer” metatag. The system may use the metatag database to conduct the search.

What is claimed is:

1. A method for improving a media content consumption experience, comprising:
presenting media content to a user device; and
presenting, in conjunction with the media content, a notification that another individual or user paid in whole or in part for presentation of the media content to the user device.
